(19) United States
(12) Patent Application Publication
(10) Pub. No.: US 2025/0254569 A1
(43) Pub. Date: Aug. 7, 2025

(54) COMMUNICATION SYSTEM FOR CONTROLLING AIRCRAFT INCLUDING GROUND BASE STATIONS OF GRID NETWORK ON AIRCRAFT DATALINK, AIRCRAFT DATALINK FREQUENCY CONFIGURING METHOD AND AIRCRAFT CONTROL HANDOVER METHOD

(71) Applicant: AGENCY FOR DEFENSE DEVELOPMENT, Daejeon (KR)

(72) Inventor: Ui Young PAK, Daejeon (KR)

(21) Appl. No.: 19/013,358

(22) Filed: Jan. 8, 2025

(30) Foreign Application Priority Data
Feb. 6, 2024 (KR) 10-2024-0017937

(51) Int. Cl. H04W 28/20; H04W 28/088; H04W 72/1263

(52) U.S. Cl. CPC H04W 28/20; H04W 28/088; H04W 72/1263

(57) ABSTRACT

Provided is an aircraft datalink frequency configuring method of an electronic apparatus, the aircraft datalink frequency configuring method including identifying data transfer volume information of an aircraft and grid information of a grid corresponding to the aircraft, and based on band allocation information, the data transfer volume information and the grid information, identifying a frequency band to be allocated to each of a common datalink (CDL) and a command and control datalink (C2DL) of the aircraft in the grid, and provided is a method for establishing a basic system that facilitates frequency allocation and operation of aircraft datalinks as a communication system for controlling an aircraft by configuring ground base stations of a grid network for an aircraft datalink.

### PRIORITY INFORMATION

This application claims the benefit of Korean Patent Application No. 10-2024-0017937, filed on Feb. 6, 2024, in the Korean Intellectual Property Office, the disclosure of which is incorporated herein by reference in its entirety.

### FIELD OF THE INVENTION

Example embodiments relate to a communication system, an aircraft datalink frequency configuring method and an aircraft control handover method for controlling an aircraft including ground base stations of a grid network for an aircraft datalink.

### DESCRIPTION OF THE RELATED ART

Manned and unmanned aircrafts equipped with intelligence, surveillance and reconnaissance (ISR) systems use a common datalink (CDL) to exchange various imagery and signal data with the ground during missions. Further, the unmanned aircraft also operates a command and control datalink (C2DL) for piloting and small data communications. In recent years, the need for real-time utilization of aircraft control data and data obtained from aircraft-mounted ISR systems via the CDL and for piloting and control via the C2DL is rapidly increasing.

Airborne ISR system operations are primarily conducted in three areas. The first is the airport area where the aircraft takes off, the second is the mission execution area, and the third is the area where the ground mission control equipment that communicates with the aircraft is located. The airport area is where the aircraft takes off, lands, maintains, and manages, and the mission area is where surveillance is conducted to collect information. The mission control equipment area on the ground is where antennas and radio transceivers are installed to communicate directly with the aircraft.

In many mountainous areas, areas with limited number of airports for aircraft takeoff and landing, and mission areas where it is difficult to secure the line of sight (LOS) state of radio waves between ground mission control equipment and aircraft, it is urgent to establish a basic system to overcome limited situations, utilize data from airborne ISR systems in real time, and, in particular, to smoothly operate the control and maneuver of an unmanned aircraft and payloads.

### SUMMARY OF THE INVENTION

An aspect provides a communication system, an aircraft datalink frequency configuring method and an aircraft control handover method for controlling an aircraft including ground base stations of the grid network for aircraft datalink. Specifically, provided is a basic system that facilitates the datalinks operation and datalink frequency allocation with respect to the aircraft.

The technical tasks to be achieved by the present example embodiments are not limited to the technical tasks described above, and other technical tasks may be inferred from the following example embodiments.

According to an aspect, there is provided an aircraft datalink frequency configuring method of an electronic apparatus, the method including identifying data transfer volume information of an aircraft and grid information of a grid corresponding to the aircraft, based on band allocation information, the data transfer volume information and the grid information, identifying a frequency band to be allocated to each of a CDL and a C2DL of the aircraft in the grid, wherein the band allocation information includes information on frequency bands in which mapped is each of at least some of information on a plurality of grids into which a mission area is divided in order for the aircraft to maintain a LOS state with a ground base station of a mission grid where the aircraft is in among the plurality of ground base stations, and each of the plurality of grids includes each of the plurality of ground base stations, information on types of datalinks supported by the aircraft including the CDL and the C2DL, and information on data transfer volume generated by equipment that is suitable to be loaded or installed onto the aircraft.

According to an example embodiment, identifying a frequency band to be allocated to each of the CDL and the C2DL of the aircraft in the grid may include identifying a frequency band to be allocated with respect to upward communication and downward communication of the CDL of the aircraft in the grid based on the data transfer volume and the grid information, in first band allocation information on a first band that is at least a portion of the band allocation information, wherein the first band is a higher frequency band than a second band corresponding to the C2DL.

According to an example embodiment, the first band allocation information may include information on the first band mapped by the grid and each range of the data transfer volume in order that a band for uplink communication and a band for downlink communication for an identical range of the data transfer volume within the first band are separated from each other, size of a frequency gap between the band for uplink communication and the band for downlink communication and size of data transfer volume corresponding to a range of the data transfer volume are proportional, each of sub-bands in the band for uplink communication and the band for downlink communication with respect to the identical range of the data transfer volume corresponds to each of the plurality of grids, and sizes of frequency separation between the sub-bands and distance difference between the plurality of grids are inversely proportional.

According to an example embodiment, identifying a frequency band to be allocated to each of the CDL and the C2DL of the aircraft in the grid may include identifying a frequency band to be allocated with respect to the C2DL of the aircraft in the grid based on the grid information in second band allocation information on a second band that is at least a portion of the band allocation information, wherein the second band is a lower frequency band than the first band corresponding to the CDL.

According to an example embodiment, the second band allocation information may include information on the second band that is mapped for each of the grid in order that each of sub-bands in the second band corresponds to each of the plurality of grids, and size of frequency separation between the sub-bands and distance difference between the plurality of grids are inversely proportional.

According to an example embodiment, the aircraft datalink frequency configuring method may further include, with an input of first configuration information to the aircraft, configuring the aircraft to transmit reconnaissance information that is to be generated by the aircraft in the grid through at least a portion of a first band that is allocated with respect to the CDL of the aircraft in the grid, and with an input of second configuration information to a base station corresponding to the grid, configuring the base station to transmit control information on the aircraft that is transmitted to the base station through at least a portion of a second band that is allocated with respect to the C2DL of the aircraft in the gird.

According to an example embodiment, the aircraft datalink frequency configuring method may further include identifying that the aircraft is scheduled to depart from the grid and enter an adjacent grid, and identifying a frequency band to be allocated to each of the CDL and the C2DL of the aircraft in the adjacent grid, based on the band allocation information, the data transfer volume information and grid information on the adjacent grid.

According to an example embodiment, the aircraft datalink frequency configuring method may further include, with an input of third configuration information to the aircraft, configuring the aircraft to transmit reconnaissance information that is to be generated by the aircraft in the adjacent grid through at least a portion of the first band that is allocated with respect to the CDL of the aircraft in the adjacent grid, and with an input of fourth configuration information to a base station corresponding to the adjacent grid, configuring the base station corresponding to the adjacent grid to transmit control information on the aircraft that is transmitted to the base station corresponding to the adjacent grid through at least a portion of a second band that is allocated with respect to the C2DL of the aircraft in the adjacent grid.

According to an example embodiment, identifying that the aircraft is scheduled to enter the adjacent grid may include identifying that the aircraft is scheduled to enter the adjacent grid based on any one of a mission plan that is pre-input with respect to the aircraft and an input of control information by an administrator of the aircraft.

According to an example embodiment, the aircraft datalink frequency configuring method may further include, with an input of fifth configuration information to the aircraft, configuring the aircraft in order that the aircraft performs communication via the CDL based on a directional antenna mounted on the aircraft, and the aircraft performs communication via the C2DL based on an omnidirectional antenna mounted on the aircraft.

According to an aspect, there is provided an electronic apparatus configured to set an aircraft datalink frequency, the electronic apparatus including a processor and a memory configured to store one or more instructions, wherein the processor is configured to, by performing the one or more instructions, identify data transfer volume information of an aircraft and grid information of a grid corresponding to the aircraft and based on band allocation information, the data transfer volume information and the grid information, identify a frequency band to be allocated to each of a CDL and a C2DL of the aircraft in the grid, wherein the band allocation information includes information on frequency bands in which mapped is each of at least some of information on a plurality of grids into which a mission area is divided in order for the aircraft to maintain a LOS state with a ground base station of a mission grid where the aircraft is in among the plurality of ground base stations, and each of the plurality of grids includes each of the plurality of ground base stations, information on types of datalinks supported by the aircraft including the CDL and the C2DL, and information on data transfer volume generated by equipment that is suitable to be loaded or installed onto the aircraft.

According to an aspect, there is provided a communication system for controlling an aircraft through a grid network with respect to an aircraft datalink, the communication system including a control tower and a ground base station that is installed at a relatively high altitude within each of grids into which a mission area is divided in order for at least one aircraft to maintain a LOS state, and each of the ground base station is connected to the control tower through each exchange station, wherein the ground base station includes a directional antenna that is connected to a CDL of the aircraft and an ominidirectional antenna that is connected to a C2DL of the aircraft, the ground base station is installed either mobile or fixed.

According to an aspect, there is provided an aircraft control handover method of an electronic apparatus, the aircraft control handover method including identifying that after the aircraft leaves a first grid including a first base station, the aircraft is scheduled to enter an adjacent second grid, through the first base station, transmitting configuration information on the aircraft including information on a second base station included in the second grid to the aircraft, transmitting configuration information on the second base station including the information on the aircraft to the second base station included in the second grid, and in response to that the aircraft is connected with the second base station, controlling the aircraft through the second base station.

According to an aspect, there is provided a non-transitory computer-readable recording medium having a program for executing an aircraft datalink frequency configuring method on a computer.

Additional aspects of example embodiments will be set forth in part in the description which follows and, in part, will be apparent from the description, or may be learned by practice of the disclosure.

According to example embodiments, it is possible to solve the communication breakdown problem that is due to a datalink disruption that occurs when an aircraft leaves the radio LOS area due to various geographical or spatial reasons when a system is operated with a 1:1 configuration of aircraft and ground control station according to existing technology.

According to example embodiments, it is possible to establish a communication system that is efficient and reduces frequency confusion by allocating the frequency of the datalink according to a predetermined frequency band depending on a grid, the data transfer volume of the aircraft, and the type of datalink.

According to example embodiments, it is possible for the communication system to operate stably with proposing a handover procedure and protocol to be performed to change the frequency when an aircraft moves between grids.

Effects of the present disclosure are not limited to those described above, and other effects may be made apparent to those skilled in the art from the following description

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a drawing illustrating an example embodiment in which an electronic apparatus for setting the aircraft datalink frequency operates in conjunction with a control tower that controls an aircraft performing a mission for each grid;

FIG. 2 is a flowchart illustrating an aircraft datalink frequency configuring method according to an example embodiment;

FIG. 3 is a drawing of frequency allocation of first band allocation information, which is a CDL frequency band according to an example embodiment;

FIG. 4 is a drawing of frequency allocation of second band allocation information, which is a C2DL frequency band according to an example embodiment;

FIG. 5 is a diagram illustrating the configuration of reconnaissance information according to an example embodiment;

FIG. 6 is a diagram illustrating the configuration of control information according to an example embodiment;

FIG. 7 is a diagram illustrating the protocol procedures among a control tower, a base station and an aircraft performed when the aircraft takes off, enters a grid after the takeoff, and lands after completing a mission according to an example embodiment;

FIG. 8A and FIG. 8B are diagrams illustrating the protocol procedures among a control tower, a base station, and an aircraft performed before the aircraft enters a grid and upon entering an adjacent grid after leaving the grid according to an example embodiment;

FIGS. 9A and 9B are diagrams illustrating communication failure that may occur when the network is not configured with grids including a base station, unlike the example embodiments described above; and

FIG. 10 illustrates a block diagram of an electronic apparatus according to an example embodiment

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated.

Expression “at least one of a, b and c” described throughout the specification may include “a alone,” “b alone,” “c alone,” “a and b,” “a and c,” “b and c” or “all of a, b and c.”

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication device ensuring portability and mobility, and include (but is not limited to) any type of handheld wireless communication device, for example, a tablet PC, a smartphone, a communication-based terminal such as international mobile telecommunication (IMT), code division multiple access (CDMA), W-code division multiple access (W-CDMA), long term evolution (LTE), or the like.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the attached drawings.

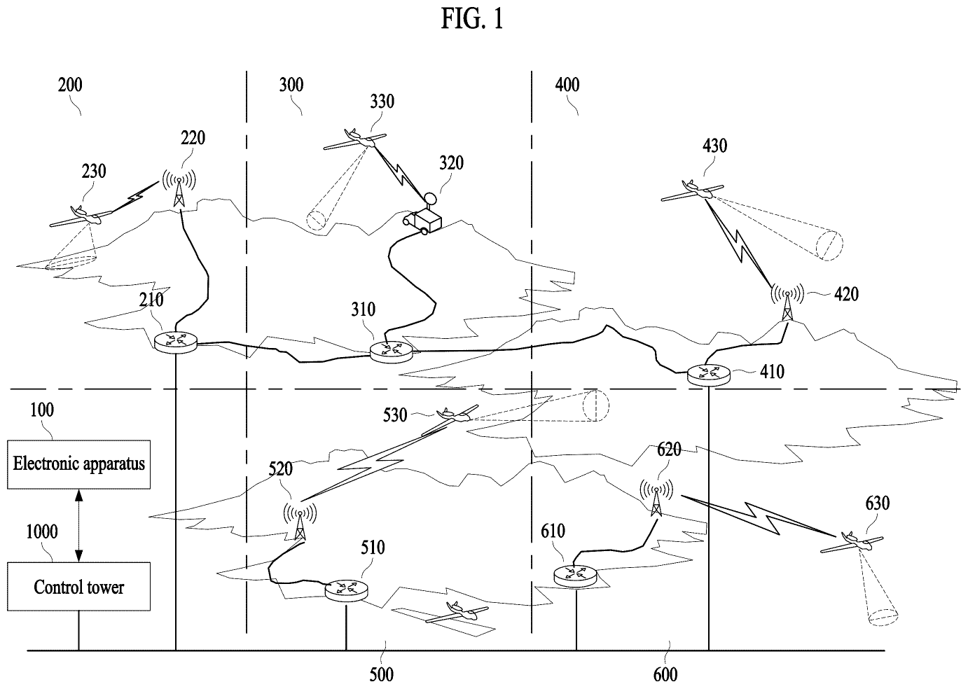

FIG. 1 is a drawing illustrating an example embodiment in which an electronic apparatus for setting the aircraft datalink frequency operates in conjunction with a control tower that controls an aircraft performing a mission for each grid.

Referring to FIG. 1, an electronic apparatus 100 may operate in conjunction with a control tower 1000 that controls aircrafts 230, 330, 430, 530 and 630 located at each grid through each of exchange stations 210, 310, 410, 510 and 610 included in each of grids 200, 300, 400, 500 and 600 and each of base stations 220, 320, 420, 520 and 620. According to an example embodiment, the electronic apparatus 100 may be installed within the control tower 1000.

According to an example embodiment, each of the grids 200, 300, 400, 500 and 600 may indicate a separate area into which a mission area is divided so that each aircraft may maintain LOS state with ground base stations. Further, each of the grids 200, 300, 400, 500 and 600 may include the base stations 220, 320, 420, 520 and 620 respectively. Here, the base station may also be installed in the form of fixed base stations 220, 420, 520 and 620, and may also be installed in the form of a mobile base station 320. Further, each of the base stations 220, 320, 420, 520 and 620 may be connected to the control tower 1000 through its respective exchange station (the exchange stations 210, 310, 410, 510 and 610). Here, the connections between each of the base stations 220, 320, 420, 520 and 620, the exchange stations 210, 310, 410, 510 and 610, and the control tower 1000 may be implemented similarly to a typical wired or wireless Internet connection. For example, each may be connected to each other via optical cables and implemented through optical communication. Further, each of the base stations may be installed at relatively high elevations within the grid. In an example embodiment, each of the base stations may be installed in a location where the LOS state may be well maintained, such as on peaks in mountainous areas.

The aircrafts 230, 330, 430, 530 and 630 included in each grid may be manned or unmanned aircraft. The aircrafts 230, 330, 430, 530 and 630 may communicate with the control tower 1000 via the CDL and the C2DL. For the communication, the aircrafts 230, 330, 430, 530 and 630 included in each grid may be equipped with a directional antenna and an omnidirectional antenna. As will be explained later, each of the aircrafts 230, 330, 430, 530 and 630 may communicate via the CDL based on the directional antennas, and via the C2DL based on the omnidirectional antennas. Further, the aircrafts 230, 330, 430, 530 and 630 included in each grid may include reconnaissance equipment that generates significant data transfer volumes over the network. For example, the aircrafts 230, 330, 430, 530 and 630 may carry observation equipment that generates significant amounts of image data, such as a visible-light camera, thermal imaging camera and radar equipment.

According to an example embodiment, the control tower 1000 may include an operating frequency storage/controller, a datalink controller, a location information storage/controller, a multi-processor unit, an airborne ISR system controller, an aircraft controller, an airborne ISR system state information generator, a data distributor, and an airborne ISR system image generator. Here, the control tower 1000 may be connected to an external data network via the data distributor, and be connected to the exchange station via a datalink controller. The airborne ISR system state information generator, the data distributor, the airborne ISR system image generator, the airborne ISR system controller and the aircraft controller may operate in conjunction with the multi-processor unit. The multi-processor unit operates in conjunction with these and transmits the results of the operation to the datalink controller, which may then transmit the results to the exchange station.

Further, according to an example embodiment, each of the base stations 220, 320, 420, 520 and 620 may include a datalink controller, a multi-processor unit, a CDL baseband unit, a C2DL baseband unit, an operating frequency storage/controller, a CDL radio processing unit, a C2DL radio processing unit, a CDL tracking antenna and a C2DL antenna that are connected to an exchange station. Here, the datalink controller and the multi-processor unit may operate in conjunction with each other, the CDL tracking antenna, the CDL radio processing unit, the CDL baseband unit, and the operating frequency storage/controller for CDL may operate in conjunction with each other, and the C2DL antenna, the C2DL radio processing unit, the C2DL baseband unit, and the operating frequency storage/controller for the C2DL may operate in conjunction with each other. Further, the CDL baseband unit and the C2DL baseband unit may be connected to the multi-processor unit and operate together.

Further, according to an example embodiment, the unmanned aircraft datalink unit may include a CDL tracking antenna, a C2DL antenna, a CDL radio processing unit, a C2DL radio processing unit, a CDL baseband unit, a C2DL baseband unit, a multi-processor unit, aircraft control linkage, an operating frequency storage/controller, a datalink controller, a location information storage/controller, aircraft ISR system control linkage, a unmanned aircraft state information generator, a unmanned aircraft control information receiver/generator and an image data receiver/generator. Here, the CDL tracking antenna, the CDL radio processing unit, and the CDL baseband unit may operate in conjunction with each other, the C2DL antenna, the C2DL radio processing unit, and the C2DL baseband unit may operate in conjunction with each other, and they may be connected to the multi-processor unit. The multi-processor unit computes and distributes the data obtained from these, and specifically, the multi-processor unit may distribute the data to the aircraft control linkage, the operating frequency storage/controller, the datalink controller, the location information storage/controller, and airborne ISR system control linkage. Further, the datalink controller may operate in conjunction with the unmanned aircraft state information generator, the unmanned aircraft control information receiver/generator, and the image data receiver/generator.

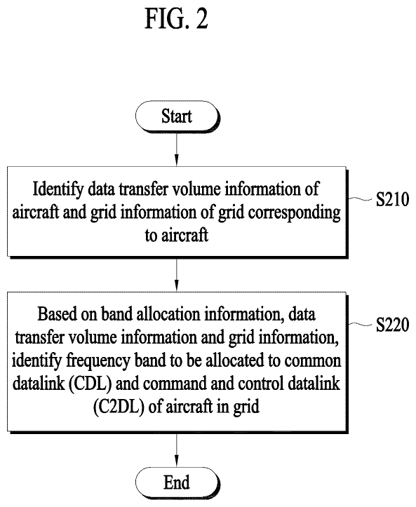

The following describes a datalink frequency configuring method according to an example embodiment with reference to the flowchart in FIG. 2.

FIG. 2 is a flowchart of an aircraft datalink frequency configuring method according to an example embodiment.

Referring to FIG. 2, in operation S210, the electronic apparatus 100 may identify data transfer volume information of the aircraft and grid information of a grid corresponding to the aircraft. In operation S220, based on band allocation information, the data transfer volume information and the grid information, the electronic apparatus 100 may identify the frequency bands to be allocated to the CDL and the C2DL of the aircraft in the grid.

Below, each operation is explained in more detail.

According to an example embodiment, before the aircraft takes off, the electronic apparatus 100 may identify the aircraft's data transfer volume information and grid information. The data transfer volume information of an aircraft may be determined based on the number and type of reconnaissance equipment installed on it and the transmission volume of each type. For example, when the aircraft is a large aircraft and carries a lot of reconnaissance equipment, the data transfer volume information may be derived largely, and for medium or small aircraft, the data transfer volume information may be derived smaller than this. However, when a small aircraft is equipped with the reconnaissance equipment with high data transfer volume, the data transfer volume information may be significantly derived. According to an example embodiment, the data transfer volume information may be identified as the sum of the data transfer volumes for each reconnaissance equipment installed on the aircraft. Further, the grid information may be identified based on the aircraft's mission plan. For example, the mission plan may include information that the aircraft is to take off from an airport area grid 500 of FIG. 1 described above and move to its upper grid 300. The electronic apparatus 100 may identify the grid information about the grid on which the aircraft will move. According to an example embodiment, the electronic apparatus 100 may identify the grid information for the grid to which the aircraft will belong for the first time after takeoff and leaving the airport area. It is also apparent that the electronic apparatus 100 may identify information about the airport area grid as the grid information.

After then, the electronic apparatus 100 may determine the frequency bands to be allocated to the CDL and the C2DL of the aircraft in the grid based on the band allocation information, the data transfer volume information, and the grid information. According to an example embodiment, the band allocation information may include information about frequency bands in which mapped are at least some of information about the above described grids, information about types of datalinks, and information about the data transfer volume. For example, the band allocation information may include information in which mapped are a specific combination of the grids, the datalink types and the data transfer volume, and/or a specific combination of the datalink type and the data transfer volume, and a specific frequency band. Here, the band allocation information may include first band allocation information for CDL and second band allocation information for the C2DL, and below, each example embodiment of determining a frequency band to be allocated to the CDL and the C2DL based on each of the first band allocation information and the second band allocation information will be described.

According to an example embodiment, the electronic apparatus 100 may determine frequency bands to be allocated for upward communication and downward communication of the CDL of an aircraft in a grid based on data transfer volume and grid information, in first band allocation information for a first band, which is at least part of band allocation information. In other words, based on a combination of the aircraft's data transfer volume and the grid information about the grid in which the aircraft will move, the electronic apparatus 100 may identify the frequency band to be allocated from the first band allocation information. Here, the first band may be a higher frequency band than the second band corresponding to the C2DL, which will be explained later. This may be to allocate high frequency bands to the CDL, which may allocate wider bandwidth since the CDL, which is responsible for transmitting and receiving image information, has a larger data transfer volume than the C2DL, which is responsible for transmitting and receiving control information.

According to an example embodiment, in the first band allocation information, each sub-band of the first band may be mapped to a combination of grids and data transfer volume in order that bands for uplink communication and downlink communication are separated for the same data transfer volume within the first band, the size of the frequency gap between the band for uplink communication and the band for downlink communication for the same data transfer volume is proportional to the size of the data transfer volume, each sub-band within the band for uplink communication and the band for downlink communication for the same data transfer volume corresponds to each of a plurality of grids, and the size of the frequency gap between sub-bands and the distance difference between the plurality of grids are inversely proportional.

The first band allocation information is explained below using specific figures and practical example embodiments. The example embodiments are described based on that it is a situation where the aircraft's data transfer volume is divided into three ranges, and type 1 is the case where the data transfer volume is the largest, type 2 is the middle, and type 3 is the case where the data transfer volume is the smallest. Here, in order for the gap between the upward communication frequency and downward communication frequency corresponding to type 1 to be the largest, the gap between the upward communication frequency and downward communication frequency corresponding to type 3 to be the smallest, and to be separated in a first band, both ends of the first band may be allocated to type 1 uplink/downlink communication, both ends inside may be allocated to type 2 uplink/downlink communication, and again both ends inside may be allocated to type 3 uplink/downlink communication. This may be to reduce the risk of communication interference by spacing out the frequency bands of uplink/downlink communication when the data transfer volume is large since the risk of communication interference increases when the data transfer volume is large.

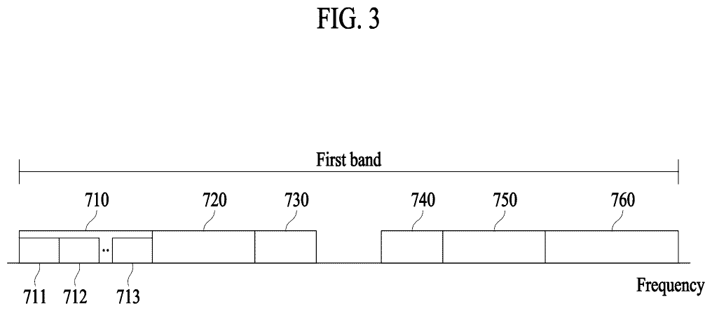

For a numerical example embodiment, when the first band is 1 GHz to 10 GHz band, the uplink/downlink communication frequency bands corresponding to type 1 may be 8 GHz to 10 GHz and 1 GHz to 3 GHz, respectively, the uplink/downlink communication frequency bands corresponding to type 2 may be from 7 GHz to 8 GHz and from 3 GHz to 4 GHz, respectively, and the uplink/downlink communication frequency bands corresponding to type 3 may be from 6.5 GHz to 7 GHz and from 2.5 GHz to 3 GHz, respectively. However, the features are mere example embodiments. Unlike the example embodiments, it is also apparent that the widths of uplink/downlink communication frequency bands may not be the same. As described above, the frequency band of uplink communication may be higher than that of downlink communication, and this may be allocating higher frequency bands to uplink communications, as the ground base station may generate more power to support the radio transmission from the aircraft than from the ground. Alternatively, if the aircraft's wireless transmission power support is available, the frequency band of the downlink communication may be set to a higher level. Further, even within a band for each of the uplink/downlink communication allocated by type, information on sub-band allocation by grid may be included in the first band allocation information. Here, the longer the distance between grids within a band for each of uplink/downlink communication, the smaller the gap between sub-bands may be, and the closer the grids are, the greater the separation between sub-bands may be. With the configuration, communication interference between grids may be minimized. An example embodiment of the above explanation may be illustrated in FIG. 3.

FIG. 3 is a drawing of frequency allocation of first band allocation information, which is a CDL frequency band according to an example embodiment.

Referring to FIG. 3, bands 710, 720, 730, 740, 750 and 760 included in the first band may be identified. Further to the example embodiments described above, the bands 710 and 760 at both ends may be frequency bands allocated to downward communication and upward communication for type 1 data transfer volume, respectively, the inner two end bands 720 and 750 may be frequency bands allocated to downward communication and upward communication for type 2 data transfer volume, respectively, and again the inner two end bands 730 and 740 may be frequency bands allocated to downward communication and upward communication for type 3 data transfer volume, respectively. Further, the frequency band allocated for downlink communications for type 1 data transfer volumes is divided into sub-bands 711, 712 and 713, and the sub-bands 711, 712 and 713 may be allocated to each grid. In an example embodiment, when the grid is shown as illustrated in FIG. 1, the two adjacent first sub-bands 711 and 712 may be allocated to a second grid 200 and a sixth grid 600, respectively, which are far from each other in FIG. 1. Further, the last sub-band, 713, may be allocated to a third grid 300, which is close to the second grid 200. For the sake of convenience of explanation, it is omitted, but each of the other bands 720, 730, 740, 750 and 760 may also be sub-bands included in each similarly thereto.

Additionally, there may be an example embodiment in which there are a plurality of aircrafts corresponding to the same data transfer volume range on the same grid. In this case, the above described sub-bands may be divided and used by each aircraft. According to an example embodiment, the first band allocated for CDL may be a high-frequency band, such as one to two digit GHz, i.e. a band from 9 GHz to 15 GHz. However, it is a mere example embodiment, and the present disclosure is not limited thereto.

Further, according to an example embodiment, the electronic apparatus 100 may identify the frequency band to be allocated with respect to the C2DL of the aircraft in a grid based on grid information in second band allocation information for a second band, which is at least part of band allocation information. In other words, the electronic apparatus 100 may identify the frequency band to be allocated from the second band allocation information based on the grid information about the grid on which the aircraft will move. Here, the second band may be a lower frequency band than the first band corresponding to the CDL described above.

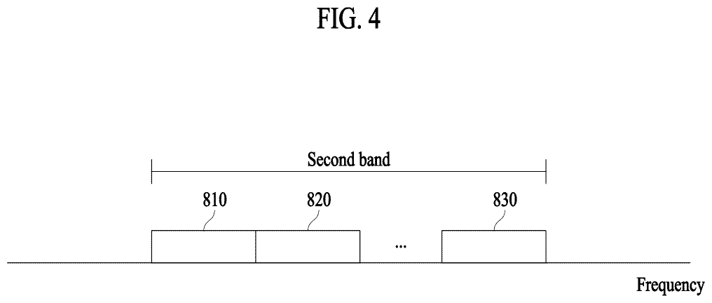

According to an example embodiment, the second band allocation information may be in a state in which each sub-band of the second band is mapped for each grid in order for that each sub-band within the second band corresponds to each of a plurality of grids, and the size of the frequency gap between sub-bands and the distance difference between the plurality of grids are inversely proportional. In other words, similar to each sub-band included in each band for uplink/downlink communication of the first band described above, it may be mapped that the frequency gap between assigned sub-bands between nearby grids is large and the frequency gap between allocated sub-bands between distant grids is small. An example embodiment of the above explanation may be illustrated in FIG. 4.

FIG. 4 is a drawing of frequency allocation of second band allocation information, which is a C2DL frequency band according to an example embodiment.

Referring to FIG. 4, two adjacent first sub-bands 810 and 820 may be allocated to the second grid 200 and the sixth grid 600, respectively, which are far apart from each other in FIG. 1. Further, the last sub-band 830 may be allocated to the third grid 300, which is close to the second grid 200. As described above, in the case of the C2DL, the data transfer volume is not large and there is little variation between aircraft, and thus frequencies may only be allocated per grid unlike the CDL. According to an example embodiment, the second band allocated for the C2DL may be a band of range from hundreds of Mhz to less than 3 GHZ, but is it a mere example embodiment. The present disclosure is not limited thereto.

Additionally, there may be an example embodiment in which there are a plurality of aircrafts in the same grid. In this case, the above described sub-bands may be divided and used by each aircraft.

In the example embodiments described above, the distance between grids may be identified by measuring the distance between the geometric centers of each grid or the distance between the base stations of each grid.

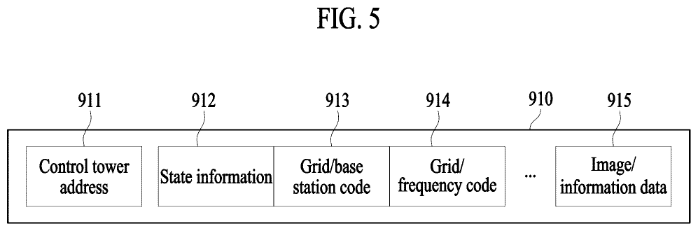

After then, with an input of the first configuration information to the aircraft, the electronic apparatus 100 may configure the aircraft to transmit reconnaissance information generated by the aircraft in the grid through at least a portion of the first band allocated with respect to the aircraft's CDL in the grid. Reference is made to FIG. 5 to explain the configuration of reconnaissance information according to an example embodiment.

FIG. 5 is a diagram illustrating the configuration of reconnaissance information according to an example embodiment.

Referring to FIG. 5, reconnaissance information 910 may include an address 911 of the ground base station or a control tower, which is the final destination to be transmitted, aircraft status and state information 912 of onboard ISR systems, a grid where the aircraft is located and a code 913 of the base station included in the grid, a grid where the aircraft is located and a frequency code 914 that is allocated to in the grid, and image/information data 915 of the onboard ISR system.

According to an example embodiment, as the reconnaissance information 910 is generated from the aircraft and transmitted to the control tower via the base station and an exchange station, additional information may be added. Specifically, the aircraft may generate the state information 912 from its contained datalink controller. After then, a datalink may be selected to transmit the state information 912, and the code 913 of the base station included in the grid where the aircraft is located and the frequency code 914 allocated in the grid where the aircraft is located may be added, and may be transmitted to the base station. Here, the frequency code 914 may be determined depending on the selection of the datalink mentioned above, and typically, the allocated frequency code for the CDL will be determined. After then, the base station may receive reconnaissance information 910 and then route the reconnaissance information 910 through the datalink controller contained within the base station. In the routing process, the base station may receive and process the state information 912, the code 913 of the base station, and the frequency code 914, and the base station may transmit state information of the base station, address information of the exchange station, and the control tower address information to the exchange station by adding them in the datalink controller. After then, the control tower 1000 may receive the reconnaissance information 910, and the control tower 1000 may route the reconnaissance information 910 from the datalink controller to each processing unit for analysis. For example, the state information 912 may be transmitted to the aircraft controller and the airborne ISR system state information generation unit, and based thereon, the aircraft may be controlled and the state information of an administrator may be provided. Further, the code 913 of the base station and the frequency code 914 may be stored in the storage and controller of operating frequency and location information. Further, the image/information data 915 may be transmitted to the airborne ISR system image generation unit to provide reconnaissance information on the administrator.

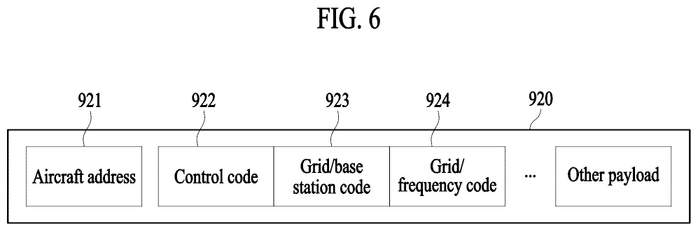

Further, with an input of second configuration information to the base station, the electronic apparatus 100 may control the aircraft in order to transmit control information for an aircraft delivered to the base station over at least a part of the second band allocated to the C2DL of the aircraft in the grid. Here, according to an example embodiment, the control information may be generated by the control tower 1000. Reference is made to FIG. 6 to explain the configuration of control information according to an example embodiment.

FIG. 6 is a diagram illustrating the configuration of control information according to an example embodiment.

Referring to FIG. 6, control information 920 may include the ground base station that is the destination of the control information 920 and an address 921 of the aircraft, a control code 922 directed to the aircraft and the onboard ISR system, a base station code 923 included in the grid where the aircraft is located, and a frequency code 924 allocated in the grid or the ground base station where the aircraft is located.

According to an example embodiment, the control information 920 may be generated from the datalink controller contained in the control tower 1000, and be transmitted through the exchange station to the base station included in the grid where the aircraft is located. Here, the control information 920 may be routed by the datalink controller of the base station. As an example of the routing process, the datalink controller of the base station may receive and process the control code 922 contained in the control information 920, and may receive and process the base station code 923 and the frequency code 924. After then, the datalink controller at the base station may select a datalink to transmit the control information 920 to the aircraft. According to an example embodiment, the C2DL could be selected as the datalink. The aircraft may receive the control information 920 like this, and may route the control information 920 to its respective processing unit for analysis via the datalink controller contained within the aircraft itself. According to an example embodiment, the datalink controller of the aircraft may route the control code 922 to the aircraft control linkage and airborne ISR system control linkage included in the aircraft, causing the aircraft and reconnaissance equipment to operate in accordance with the control code 922. Further, the base station code 923 and the frequency code 924 may be routed to the operating frequency storage/controller and location information storage/controller, and the base station code 923 and the frequency code 924 may be received and processed.

Below is a description of the handover process when an aircraft leaves the grid and enters an adjacent grid. Here, identifying that an aircraft is about to enter an adjacent grid, when the aircraft is unmanned, may be based on either a previously entered mission plan for the aircraft or control information entered by an administrator of the aircraft. In other words, the electronic apparatus 100 may identify whether the aircraft is about to enter an adjacent grid based on whether the aircraft is scheduled to move to the adjacent grid according to the mission plan or in respond to the input of the control information.

After then, similar to the above described example embodiment, based on band allocation information, data transfer volume information, and grid information for adjacent grids, the electronic apparatus 100 may identify the frequency bands to be allocated to the aircraft's CDL and C2DL in an adjacent grid, respectively. Further, with an input of third configuration information to the aircraft, the electronic apparatus 100 may configure the aircraft to transmit reconnaissance information generated by the aircraft in the adjacent grid through at least a portion of the first band allocated with respect to the aircraft's CDL in the adjacent grid. Further, with an input of fourth configuration information to a base station corresponding to the adjacent grid, the electronic apparatus 100 may configure a base station corresponding to an adjacent grid to transmit control information about the aircraft transmitted to the base station over at least part of the second band that is allocated with respect to the C2DL of the aircraft in the adjacent grid. Here, the process of identifying the frequency bands to be allocated to each aircraft's CDL and C2DL in the adjacent grid may be similar to the previously described example embodiments of identifying a frequency band to be allocated to each of the aircraft's CDL and C2DL in the grid the aircraft enters first after takeoff. Further, operations of aircraft and base station according to an input of the third configuration information and an input of the fourth configuration information may also be similar to the operations of the aircraft and base station according to the input of the first and second configuration information described above. The reconnaissance information and the control information may also be similar to those described with reference to FIGS. 5 and 6.

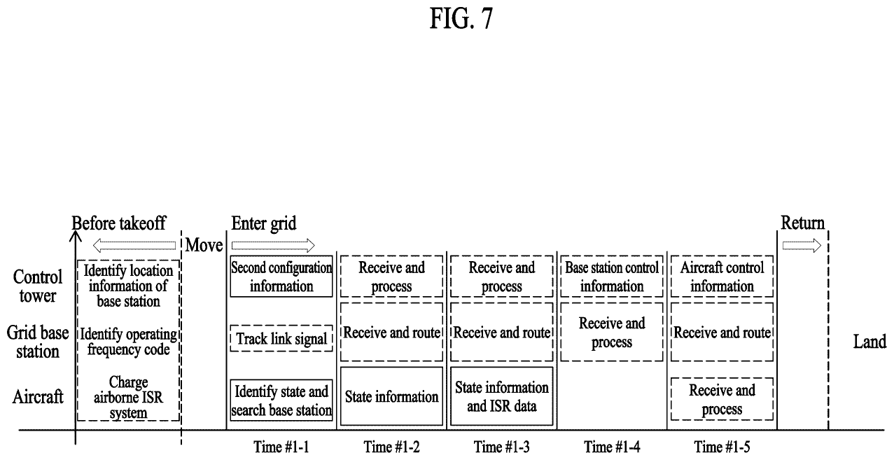

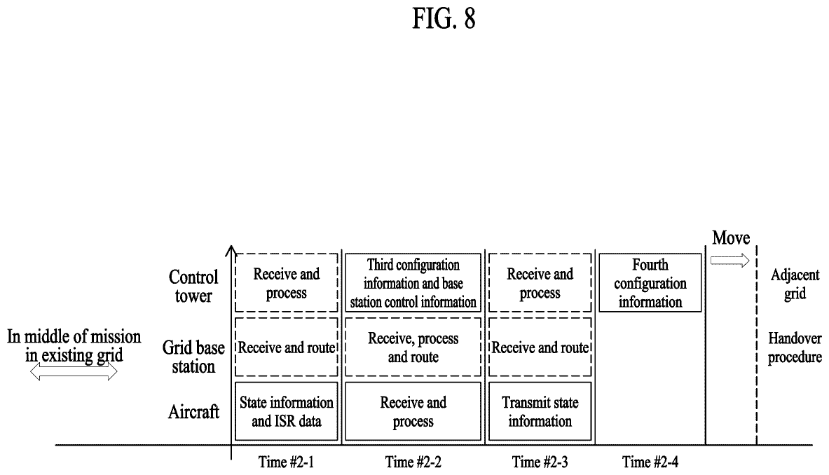

The process described above may be generalized: the electronic apparatus 100 may identify that after an aircraft leaves a first grid containing a first base station, the aircraft is scheduled to enter an adjacent second grid; configuration information about the aircraft, including information about a second base station included in a second grid is transmitted to the aircraft, through the first base station; and the configuration information about the second base station containing information about the aircraft is transmitted to the second base station included in the second grid. Accordingly, after the aircraft enters the second grid, the aircraft may be connected to the second base station, and thus the aircraft may be controlled via the second base station. Here, the configuration information for the aircraft may be similar to the third configuration information described above, and the configuration information for the base station may be similar to the fourth configuration information described above. Hereinafter, example embodiments with reference to FIG. 7, FIG. 8A and FIG. 8B will be described for protocols of the control tower 1000, the base station and the aircraft being performed when the aircraft takes off, enters a grid, leaves the grid and enters an adjacent grid.

FIG. 7 is a diagram illustrating the protocol procedures among a control tower, a base station and an aircraft performed when the aircraft takes off, enters a grid after the takeoff, and lands after completing a mission according to an example embodiment.

Referring to FIG. 7, before the takeoff, the control tower may identify the location information of ground base stations located on a mission grid. Further, a base station may identify an allocated operating frequency code for a grid that the base station itself is part of, and the aircraft may be in a state that the aircraft itself charges the location information of the base station of the grid where it will perform its mission and the operating frequency code as first configuration information in the ISR system. After then, when an aircraft takes off and enters the grid to perform its mission, in time #1-1, the control tower may transmit second configuration information to the base station to set up the base station. Here, in response to the second configuration information, the base station may be tracking the link signal that is to be transmitted from the aircraft in the frequency band, and the aircraft may check its own conditions and transmit link signals to find a base station. After then, in time #1-2, as the link signal is connected to the base station, the aircraft may transmit state information to the base station by continuously being connected the base station through the link signals. The base station may be continuously connected with the aircraft through the link signals and route the state information transmitted from the aircraft to the control tower, and the control tower may receive and process the state information. After then, in time #1-3, the aircraft may transmit the above described reconnaissance information, including state information and ISR data, i.e. image/information data, to the base station, the base station may route the reconnaissance information to the control tower, and the control tower may receive and process the reconnaissance information. When the mission is completed, in time #1-4, the control tower may transmit configuration information to the base station that the aircraft is to depart from the grid corresponding to the base station and land, and the base station may receive the configuration information. After then, in time #1-5, the control tower may transmit control information directing the aircraft to land. Even in the middle of the processes described above, the base station and the aircraft may remain continuously connected to each other via the link signals.

FIG. 8A and FIG. 8B are diagrams illustrating the protocol procedures among a control tower, a base station, and an aircraft performed before the aircraft enters a grid and upon entering an adjacent grid after leaving the grid according to an example embodiment.

Referring to FIG. 8A, in time #2-1, when the aircraft is on a mission in a specific grid, the aircraft may transmit reconnaissance information, including state information and ISR data, to the base station, the base station may route the reconnaissance information to the control tower, and the control tower may receive and process the reconnaissance information. After then, in time #2-2, the control tower may transmit grid control information to the aircraft as third configuration information to move to the adjacent grid to enter, and may transmit the control information to the base station that the aircraft is about to leave the grid. The base station may receive the third configuration information and route the third configuration information to the aircraft, and the aircraft may receive and process the third configuration information. After then, in time #2-3, the aircraft may transmit state information including information that a handoff will occur after moving to the adjacent grid to the control tower via the base station. In time #2-4, the control tower may transmit control information on a new base station installed in the adjacent grid as fourth configuration information to the new base station installed in the adjacent grid to which the aircraft is scheduled to move. In the middle of the processes described above, the base station and the aircraft may remain continuously connected to each other via the link signals.

Referring to FIG. 8B, before the aircraft entering the adjacent grid, as described with reference to FIG. 8A, the unmanned aircraft may perform a process of identifying the frequency to which the unmanned aircraft is scheduled to connect and location setting status of the base station to which the aircraft is scheduled to move and connect. In time #3-1 connected to time #2-4 of FIG. 8A, the control tower may transmit relevant control information to the base station on the ground where the aircraft is scheduled to move, and the aircraft may check conditions and search a base station. In time #3-2, as the link signal connects to the base station and the aircraft communicates with the base station, the aircraft may transmit the state information to the base station. While being continuously connected with the aircraft through link signals, the base station may route the state information transmitted from the aircraft and transmit the state information to the control tower, and the control tower may receive and process the state information. After then, in time #3-3, the aircraft may transmit the reconnaissance information, including the state information and the ISR data, i.e. image/information data, to the base station, the base station may route this and forward the reconnaissance information to the control tower, and the control tower may receive and process the reconnaissance information. When the mission is completed, in time #3-4, to the base station, the control tower may transmit the control information about the base station including the information that the aircraft will depart from the grid corresponding to the base station and land, and the base station may receive the control information about the base station. After then, in time #3-5, the control tower may transfer the control information about the aircraft by which the aircraft is instructed to land. Even in the middle of the processes described above, the base state and the aircraft may remain continuously connected to each other via the link signals.

The electronic apparatus 100 may set the aircraft by inputting fifth configuration information before the aircraft takes off in order for the aircraft to communicate via the CDL based on the directional antenna mounted on the aircraft, and to communicate via the C2DL based on the omnidirectional antenna mounted on the aircraft. Since the CDL has a relatively large data transfer volume, it may communicate based on the directional antennas and since the C2DL has a relatively small data transfer volume, it may be used for communication based on the omnidirectional antennas, and thus the aircraft may be configured based thereon.

According to the example embodiments described above, a series of communication processes may be performed after an aircraft takes off, performs a mission on one or more grids, and then lands.

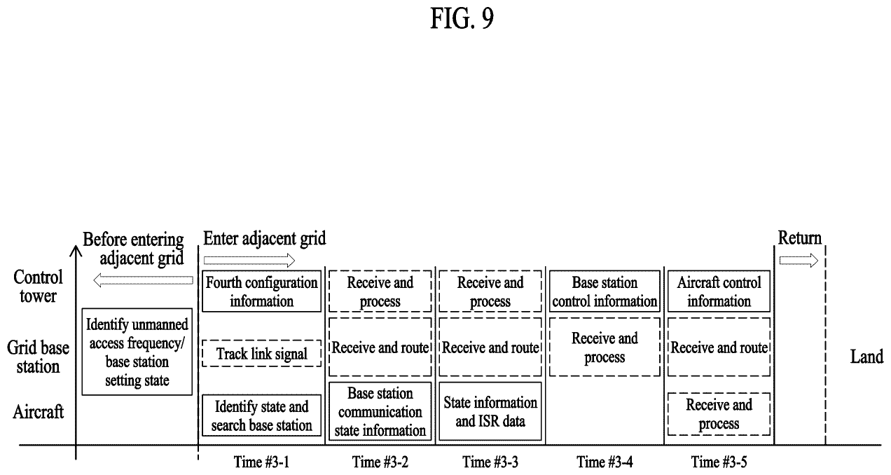

Hereinafter, described based on FIG. 9A and 9B is an example embodiment that is related to an aircraft datalink frequency configuring method.

FIGS. 9A and 9B are diagrams illustrating communication failure that may occur when the network is not configured with grids including a base station, unlike the example embodiments described above.

Referring to FIG. 9A, identified is a situation where an aircraft not located within the coverage area of the control tower 1000 is controlled via the base station 220. Here, even though the aircraft is easily controlled within the coverage area of the base station, as illustrated in FIG. 9B, when the aircraft is out of the coverage of the base station 220, controlling the aircraft may be difficult. However, according to example embodiments of the present disclosure, even if the aircraft goes out of the coverage of the base station 220 and link interruptions occur intermittently, the control tower 1000 may control the aircraft via a ground base station installed in an adjacent grid.

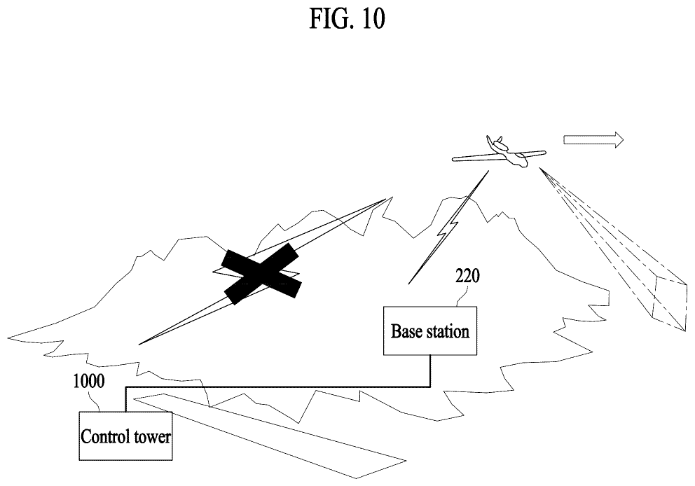

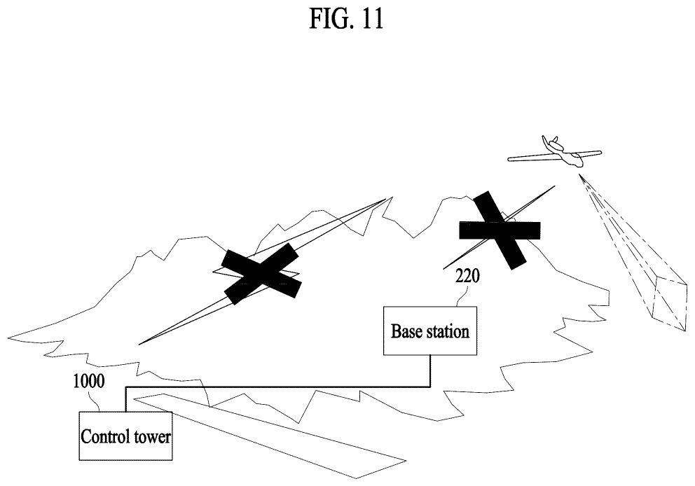

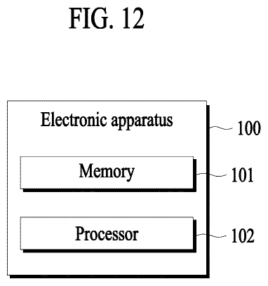

FIG. 10 illustrates a block diagram of an electronic apparatus according to an example embodiment.

According to an example embodiment, the electronic apparatus 100 may include a memory 101 and a processor 102. FIG. 10 illustrates only components of the electronic apparatus 100 which are relevant to example embodiments. Therefore, it will be understood by those skilled in the art related to the present embodiment that other general components may be included in addition to the components illustrated in FIG. 10. In an example embodiment, the processor 102 may be included in a controller.

The processor 102 may control the overall operation of the electronic apparatus 100 and process data and signals. The processor 102 may consist of at least one hardware unit. Further, the processor 102 may be operated by one or more software modules generated by executing program codes stored in the memory 101. Since the processor 102 includes the memory, the processor 102 may control the overall operation of the electronic apparatus 100 and process data and signals by executing the program codes stored in memory.

The processor 102 may be configured, by at least one instructions being performed, to identify the data transfer volume information of the aircraft and the grid information of the grid corresponding to the aircraft, and identify the frequency band to be allocated to each CDL and C2DL of the aircraft in the grid based on band allocation information, data transfer volume information and grid information.

According to an example embodiment, the electronic apparatus 100 may additionally include a transceiver for performing wired/wireless communication. The electronic apparatus 100 may communicate with an external electronic apparatus using a transceiver. The external electronic apparatus may be a terminal or a server. Further, communication technologies utilized by the transceiver may include global system for mobile communication (GSM), code division multi access (CDMA), long term evolution (LTE), 5G, wireless LAN (WLAN), wireless-fidelity (Wi-Fi), Bluetooth™, radio frequency identification (RFID), infrared data association (IrDA), ZigBee, and near field communication (NFC).

An apparatus according to the above described example embodiments may include a processor, a memory for storing and executing program data, permanent storage such as disk drives, communication ports to communicate with external devices and user interface devices such as touch panels, keys and buttons. Methods implemented as software modules or algorithms are computer readable codes or program instructions executable on the processor, and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, C #, python, Java, assembler, etc., including various algorithms implemented as a combination of data structures, processes, routines, or other programming constructs. Functional aspects may be implemented in an algorithm running on one or more processors. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

What is claimed is:

1. An aircraft datalink frequency configuring method of an electronic apparatus, the method comprising:
identifying data transfer volume information of an aircraft and grid information of a grid corresponding to the aircraft; and
based on band allocation information, the data transfer volume information and the grid information, identifying a frequency band to be allocated to each of a common datalink (CDL) and a command and control datalink (C2DL) of the aircraft in the grid,
wherein the band allocation information comprises information on frequency bands mapped to one or more of:
information on a plurality of grids into which a mission area is divided in order for the aircraft to maintain a line of sight (LOS) state with a ground base station of a mission grid where the aircraft is in among the plurality of ground base stations, and each of the plurality of grids comprises each of the plurality of ground base stations;
information on types of datalinks supported by the aircraft including the CDL and the C2DL; and
information on data transfer volume generated by equipment that is suitable to be loaded or installed onto the aircraft.

2. The aircraft datalink frequency configuring method of claim 1, wherein identifying a frequency band to be allocated to each of the CDL and the C2DL of the aircraft in the grid comprises:
identifying a frequency band to be allocated with respect to upward communication and downward communication of the CDL of the aircraft in the grid based on the data transfer volume and the grid information, in first band allocation information on a first band that is at least a portion of the band allocation information,
wherein the first band is a higher frequency band than a second band corresponding to the C2DL.

3. The aircraft datalink frequency configuring method of claim 2, wherein the first band allocation information comprises information on the first band mapped by the grid and each range of the data transfer volume in order that:
a band for uplink communication and a band for downlink communication for an identical range of the data transfer volume within the first band are separated from each other;
size of a frequency gap between the band for uplink communication and the band for downlink communication and size of data transfer volume corresponding to a range of the data transfer volume are proportional;
each of sub-bands in the band for uplink communication and the band for downlink communication with respect to the identical range of the data transfer volume corresponds to each of the plurality of grids; and
sizes of frequency separation between the sub-bands and distance difference between the plurality of grids are inversely proportional.

4. The aircraft datalink frequency configuring method of claim 1, wherein identifying a frequency band to be allocated to each of the CDL and the C2DL of the aircraft in the grid comprises
identifying a frequency band to be allocated with respect to the C2DL of the aircraft in the grid based on the grid information in second band allocation information on a second band that is at least a portion of the band allocation information,
wherein the second band is a lower frequency band than the first band corresponding to the CDL.

5. The aircraft datalink frequency configuring method of claim 4, wherein the second band allocation information comprises information on the second band that is mapped for each of the grid in order that:
each of sub-bands in the second band corresponds to each of the plurality of grids; and
size of frequency separation between the sub-bands and distance difference between the plurality of grids are inversely proportional.

6. The aircraft datalink frequency configuring method of claim 1, further comprising:
with an input of first configuration information to the aircraft, configuring the aircraft to transmit reconnaissance information that is to be generated by the aircraft in the grid through at least a portion of a first band that is allocated with respect to the CDL of the aircraft in the grid; and
with an input of second configuration information to a base station corresponding to the grid, configuring the base station to transmit control information on the aircraft that is transmitted to the base station through at least a portion of a second band that is allocated with respect to the C2DL of the aircraft in the gird.

7. The aircraft datalink frequency configuring method of claim 1, further comprising:
identifying that the aircraft is scheduled to depart from the grid and enter an adjacent grid; and
identifying a frequency band to be allocated to each of the CDL and the C2DL of the aircraft in the adjacent grid, based on the band allocation information, the data transfer volume information and grid information on the adjacent grid.

8. The aircraft datalink frequency configuring method of claim 7, further comprising:
with an input of third configuration information to the aircraft, configuring the aircraft to transmit reconnaissance information that is to be generated by the aircraft in the adjacent grid through at least a portion of the first band that is allocated with respect to the CDL of the aircraft in the adjacent grid; and
with an input of fourth configuration information to a base station corresponding to the adjacent grid, configuring the base station corresponding to the adjacent grid to transmit control information on the aircraft that is transmitted to the base station corresponding to the adjacent grid through at least a portion of a second band that is allocated with respect to the C2DL of the aircraft in the adjacent grid.

9. The aircraft datalink frequency configuring method of claim 7, wherein identifying that the aircraft is scheduled to enter the adjacent grid comprises,
identifying that the aircraft is scheduled to enter the adjacent grid based on any one of a mission plan that is pre-input with respect to the aircraft and an input of control information by an administrator of the aircraft.

10. The aircraft datalink frequency configuring method of claim 1, further comprising,
with an input of fifth configuration information to the aircraft, configuring the aircraft in order that:
the aircraft performs communication via the CDL based on a directional antenna mounted on the aircraft; and
the aircraft performs communication via the C2DL based on an omnidirectional antenna mounted on the aircraft.

11. A non-transitory computer-readable recording medium having a program for executing an aircraft datalink frequency configuring method on a computer,
wherein the aircraft datalink frequency configuring method comprising:
identifying data transfer volume information of an aircraft and grid information of a grid corresponding to the aircraft; and
based on band allocation information, the data transfer volume information and the grid information, identifying a frequency band to be allocated to each of a CDL and a C2DL of the aircraft in the grid,
wherein the band allocation information comprises information on frequency bands mapped to one or more of:
information on a plurality of grids into which a mission area is divided in order for the aircraft to maintain a LOS state with a ground base station of a mission grid where the aircraft is in among the plurality of ground base stations, and each of the plurality of grids comprises each of the plurality of ground base stations;
information on types of datalinks supported by the aircraft including the CDL and the C2DL; and
information on data transfer volume generated by equipment that is suitable to be loaded or installed onto the aircraft.

12. An electronic apparatus configured to set an aircraft datalink frequency, the electronic apparatus comprising:
a processor; and
a memory configured to store one or more instructions,
wherein the processor is configured to, by performing the one or more instructions:
identify data transfer volume information of an aircraft and grid information of a grid corresponding to the aircraft; and
based on band allocation information, the data transfer volume information and the grid information, identify a frequency band to be allocated to each of a CDL and a C2DL of the aircraft in the grid,
wherein the band allocation information comprises information on frequency bands mapped to one or more of:
information on a plurality of grids into which a mission area is divided in order for the aircraft to maintain a LOS state with a ground base station of a mission grid where the aircraft is in among the plurality of ground base stations, and each of the plurality of grids comprises each of the plurality of ground base stations;
information on types of datalinks supported by the aircraft including the CDL and the C2DL; and
information on data transfer volume generated by equipment that is suitable to be loaded or installed onto the aircraft.

13. A communication system for controlling an aircraft through a grid network with respect to an aircraft datalink, the communication system comprising:
a control tower; and
a ground base station that is installed at a relatively high altitude within each of grids into which a mission area is divided in order for at least one aircraft to maintain a LOS state, and each of the ground base station is connected to the control tower through each exchange station,
wherein the ground base station comprises:
a directional antenna that is connected to a CDL of the aircraft; and
an ominidirectional antenna that is connected to a C2DL of the aircraft, and
the ground base station is installed either mobile or fixed.

14. An aircraft control handover method of an electronic apparatus, the aircraft control handover method comprising:
identifying that after the aircraft leaves a first grid including a first base station, the aircraft is scheduled to enter an adjacent second grid;
through the first base station, transmitting configuration information on the aircraft including information on a second base station included in the second grid to the aircraft;
transmitting configuration information on the second base station including the information on the aircraft to the second base station included in the second grid; and
in response to that the aircraft is connected with the second base station, controlling the aircraft through the second base station.
